(19) United States
(12) Patent Application Publication
(10) Pub. No.: US 2013/0046553 A1
(43) Pub. Date: Feb. 21, 2013

(54) MEDICAL TREATMENT INFORMATION INPUT DEVICE, COMPUTER READABLE STORAGE MEDIUM, AND MEDICAL TREATMENT INFORMATION INPUT METHOD

(71) Applicants: Nobuyuki HIRAKAWA, Kawasaki (JP); Masae Isobe, Yokohama (JP); Yukio Saito, Kawasaki (JP)

(72) Inventors: Nobuyuki HIRAKAWA, Kawasaki (JP); Masae Isobe, Yokohama (JP); Yukio Saito, Kawasaki (JP)

(73) Assignee: FUJITSU LIMITED, Kawasaki-shi (JP)

(21) Appl. No.: 13/571,648

(22) Filed: Aug. 10, 2012

(30) Foreign Application Priority Data
Aug. 12, 2011 (JP) 2011-177300

(51) Int. Cl. G06Q 50/22

(52) U.S. Cl. 705/2

(57) ABSTRACT

A technology disclosed in the application which receives a reexamination appointment date as an input through a display screen displaying medical treatment information of a patient. The technology disclosed unit which refers to a storage unit which stores information representing an availability of the reexamination appointment date as an examination appointment date for the respective categories of a plurality of examinations including an examination which is granted to the patient is received, and determines an availability of the reexamination appointment date received by the execution unit as the examination appointment date, in a case where a display request for an appointment screen for the examination. The technology disclosed which outputs the appointment screen in a format in which the reexamination appointment date is available as the examination appointment date, in a case where the determination unit determines that the reexamination appointment date is available as the examination appointment date.

### CROSS-REFERENCE TO RELATED APPLICATION

This application is based upon and claims the benefit of priority of the prior Japanese Patent Application No. 2011-177300, filed on Aug. 12, 2011, the entire contents of which are incorporated herein by reference.

### FIELD

The embodiments discussed herein are directed to a medical treatment information input device, a computer readable storage medium, and a medical treatment information input method.

### BACKGROUND

Recently, an electronic medical chart system is widely used in medical practice. A user who uses the electronic medical chart system registers medical treatment information such as a diagnosis result and an examination result of an examinee in a database of the electronic medical chart system. Further, the users, for example, include physicians, nurses, and medical personnel such as pharmacists. In addition, the examinees, for example, include those who undergo physical examinations and healthy people such as pregnant women, as well as patients such as the ailing and the injured. In addition, hereinafter, a medical chart which is used in the electronic medical chart system will be referred to as an “electronic medical chart”.

For example, in the electronic medical chart system, an editor (hereinafter, simply denoted by an “editor”) corresponding to the electronic medical chart system is used in order to register the medical treatment information in the electronic medical chart. For example, when examining an examinee on the outpatient basis, a physician activates the editor using a terminal at hand. Then, the physician examines the examinee, and inputs the medical treatment information such as a diagnosis result, an examination result, a therapy method, and future plans using the editor. Thereafter, when the input medical treatment information is stored as data, the data of the input medical treatment information is transmitted to the database of the electronic medical chart system, and the electronic medical chart is updated.

In addition, for example, tools provided on the editor include a reexamination appointment tool and an examination appointment tool. The reexamination appointment tool is a tool for making an appointment of the reexamination; for example, the tool receives the contents of the reexamination and the appointment date as an input. In addition, the examination appointment tool is a tool for making an examination appointment; for example, the tool receives the contents of the examination and the appointment date as an input, and issues an order to an examination department.

In addition, for example, a technology of supporting the examination appointment also is present in the electronic medical chart system. The technology, for example, in a case where two examinations are appointed at the same time, when a first examination is appointed, a second examination is appointed at a day nearest to the appointment date.

Patent document 1: Japanese Laid-open Patent Publication 2008-269124

Patent document 2: Japanese Laid-open Patent Publication 2003-085277

However, in the related art described above, the input burden on a physician has not been lightened. For example, when the reexamination appointment and the examination appointment are arranged for an examinee visiting a hospital on the outpatient basis, a reexamination appointment date and an examination appointment date may be arranged at the same date in consideration of the burden on the examinee. In this case, since the physician necessarily sets each of the reexamination appointment tool and the examination appointment tool to the same date, the input burden on the physician has not been lightened.

In addition, as a solution to the problems described above, it is considered that after arranging the reexamination appointment, the input reexamination appointment date is transferred as an examination appointment date, so that the input of the examination appointment date is skipped. However, depending on the category of the examination, there are examinations which are not necessarily arranged on the same date as that of the reexamination. For example, in a case where an examination appointment frame is set in the examination department and the examination appointment is not arranged depending on only a schedule of the medical treatment division, it is difficult to necessarily arrange the examination on the same date as that of the reexamination. In this case, even if the input reexamination appointment date is transferred to the examination appointment tool, the examination appointment date is to be newly input. Therefore, the burden on the physician has not been lightened.

### SUMMARY

According to an aspect of an embodiment, a medical treatment information input device includes a processor, and a memory that stores information representing an availability of a reexamination appointment date as an examination appointment date for respective categories of a plurality of examinations, wherein the processor executes: determining including referring to the memory, and determining availability of the reexamination appointment date input through a display screen displaying medical treatment information of a patient as an examination appointment date, and outputting the appointment screen in a format in which the reexamination appointment date is available as the examination appointment date in a case where it is determined that the reexamination appointment date is available as the examination appointment date through the determining of the availability.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a medical treatment information input device according to a first embodiment;

FIG. 2 is a diagram illustrating an example of a data structure of a transfer storage unit;

FIG. 3 is a diagram illustrating an example of an editor screen which is output by an execution unit;

FIG. 4 is a diagram illustrating an example of a display screen of an examination list;

FIG. 5 is a diagram illustrating an example of an appointment screen which is output by an output unit;

FIG. 6 is a diagram illustrating an example of the appointment screen which is output by the output unit;

FIG. 7 is a flowchart illustrating a processing sequence of the medical treatment information input device according to the first embodiment;

FIG. 8 is a flowchart illustrating a processing sequence of the medical treatment information input device according to the first embodiment;

FIG. 9 is a block diagram illustrating a functional configuration of a medical treatment information input device according to a second embodiment;

FIG. 10 is a diagram illustrating an example of the appointment screen which is output by the output unit;

FIG. 11 is a flowchart illustrating a processing sequence of the medical treatment information input device according to the second embodiment;

FIG. 12 is a diagram illustrating an example of the application to a data center; and

FIG. 13 is a diagram illustrating a computer which executes a medical treatment information input program.

### DESCRIPTION OF EMBODIMENTS

Herein below, embodiments of a medical treatment information input device, a medical treatment information input program, and a medical treatment information input method disclosed in the application will be described in detail with reference to the drawings. Further, the invention is not limited by the embodiments. The embodiments can be appropriately combined to each other unless there is no inconsistency in processing contents.

### [a] First Embodiment

Configuration

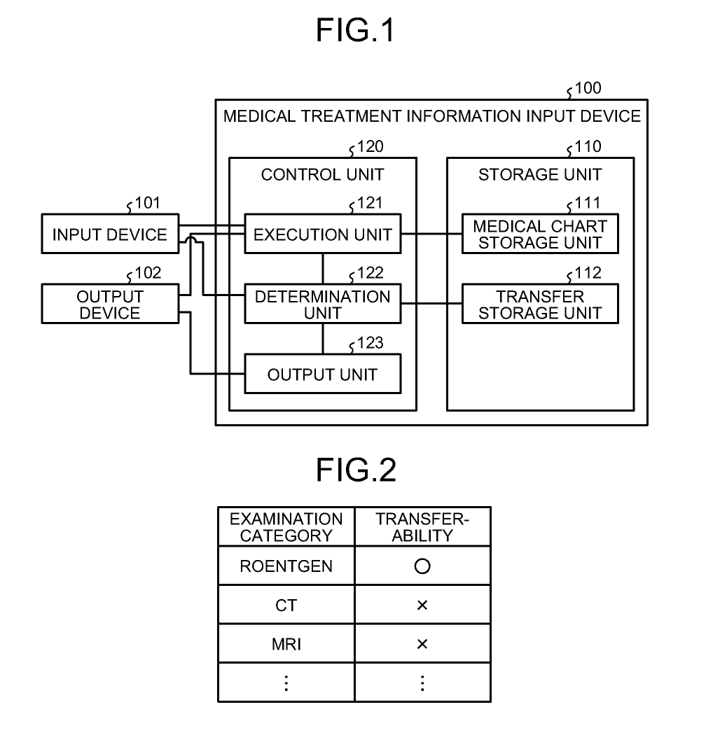

An example of a functional configuration of a medical treatment information input device according to a first embodiment will be described. FIG. 1 is a block diagram illustrating the functional configuration of the medical treatment information input device according to the first embodiment. As illustrated in FIG. 1, a medical treatment information input device 100 is provided with a storage unit 110 and a control unit 120. In addition, the medical treatment information input device 100 is connected to an input device 101 and an output device 102. The medical treatment information input device 100, for example, corresponds to a personal computer.

The input device 101 receives various kinds of information as inputs. For example, the input device 101 receives an instruction to display an electronic medical chart of an examinee from a user. For example, the input device 101 receives medical treatment information as an input from a physician. For example, the input device 101 receives the instruction on the appointments for a reexamination and an examination as an input from the physician. In addition, for example, the input device 101 outputs the various kinds of received information to an execution unit 121. For example, the input device 101 corresponds to a keyboard, a mouse, a media reading device, or various kinds of sensors such as a thermometer and a hygrometer. Further, the users, for example, include physicians, nurses, and medical personnel such as pharmacists. In addition, the examinees, for example, include those who undergo physical examinations and healthy people such as pregnant women, as well as patients such as the ailing and the injured. In addition, hereinafter, a medical chart which is used in the medical treatment information input device 100 will be referred to as an “electronic medical chart”.

The output device 102 outputs various kinds of information. For example, the output device 102 displays an output screen which outputs the medical treatment information. In addition, for example, the output device 102 displays an input screen which is used by the user to input the medical treatment information in the electronic medical chart. In addition, for example, the output device 102 corresponds to a display, a monitor, or the like.

The storage unit 110 is provided with a medical chart storage unit 111 and a transfer storage unit 112. The storage unit 110, for example, corresponds to a semiconductor memory element such as RAM (Random Access Memory), a ROM (Read Only Memory), and flash memory, and a storage device such as a hard disk and an optical disk.

The medical chart storage unit 111 stores the electronic medical chart in which the medical treatment information on the examinee is registered. In addition, the electronic medical chart stored in the medical chart storage unit 111 is used by the execution unit 121 which will be described later. For example, the execution unit 121 registers the medical treatment information received from the input device 101 in the electronic medical chart. In addition, for example, the execution unit 121 outputs the electronic medical chart read from the medical chart storage unit 111 to the output device 102, and causes the output device 102 to display the chart. Further, hereinafter, information registered in the electronic medical chart will be referred to as the “medical treatment information”. Further, the electronic medical chart will be registered for every patient. Furthermore, in a case where a patient takes medical treatments several times, a plurality of pieces of the medical treatment information will be registered in the electronic medical chart of the patient.

The transfer storage unit 112 stores the respective categories of a plurality of examinations including the examination with being associated with information representing the availability of a reexamination appointment date as an examination appointment date. For example, the transfer storage unit 112 stores the category of the examination with being associated with information representing the transferability of the input reexamination appointment date to the examination appointment date. FIG. 2 is a diagram illustrating an example of a data structure of the transfer storage unit. As illustrated in FIG. 2, the transfer storage unit 112, for example, stores an “examination category” with being associated with “transferability”. Among these, the examination category represents the category of the examination. The transferability represents the transferability of the input reexamination appointment date to the examination appointment date. The transferability of the input reexamination appointment date to the examination appointment date means that the examination appointment date can be set to the very date of the input reexamination appointment date. For example, the transferability “◯” represents that the input reexamination appointment date is transferable to the examination appointment date. In addition, for example, the transferability “×” represents that the input reexamination appointment date is not transferable to the examination appointment date. For example, the transferable examination includes an examination of the category of which an examination result is expected on the very day of the examination and an examination of the category in which there is no need to designate an appointment frame. Further, the reexamination appointment date includes the appointment date of the next diagnosis, and the examination appointment date includes the appointment date of the examination. In addition, the transfer storage unit 112 is an example of the storage unit. Further, the transfer storage unit 112 may be configured to store only the available examination category. In addition, the transferring means that the computer acquires the reexamination appointment date on the editor to use the acquired date as the examination appointment date of an appointment screen.

As illustrated in FIG. 2, the transfer storage unit 112, for example, stores “roentgen” of the examination category with being associated with “◯” in the transferability. In other words, the transfer storage unit 112 stores that the roentgen is an examination of which the input reexamination appointment date is transferable to the examination appointment date. In addition, the transfer storage unit 112 stores other examination categories in the similar manner. Further, the correspondence relation between the examination category and the transferability stored in the transfer storage unit 112 may be arbitrarily set by staffs who use the medical treatment information input device 100.

The control unit 120 is provided with the execution unit 121, a determination unit 122, and an output unit 123. The functions of the control unit 120, for example, may be realized using an integrated circuit such as an ASIC (Application Specific Integrated Circuit) and an FPGA (Field Programmable Gate Array). In addition, the functions of the control unit 120, for example, may be realized by causing a CPU (Central Processing Unit) to execute predetermined programs.

The execution unit 121 performs various processes related to registering, editing, updating, displaying, and the like of the electronic medical chart. For example, the execution unit 121 receives the reexamination appointment date as an input through a display screen displaying the medical treatment information of the patient. In addition, for example, the execution unit 121 receives an instruction to display the electronic medical chart of the examinee from the input device 101, and acquires the electronic medical chart from the medical chart storage unit 111. The execution unit 121 displays, on the output device 102, either an output screen which displays the medical treatment information on the current medical treatment on the acquired electronic medical chart, or an input screen which is used by the user to input the medical treatment information on the electronic medical chart. Further, both the output screen and the input screen are screens to be displayed on the output device 102 through the functions of the editor. Herein, the output screen and the input screen displayed on the output device 102 through the functions of the editor will be referred to as “editor screens”.

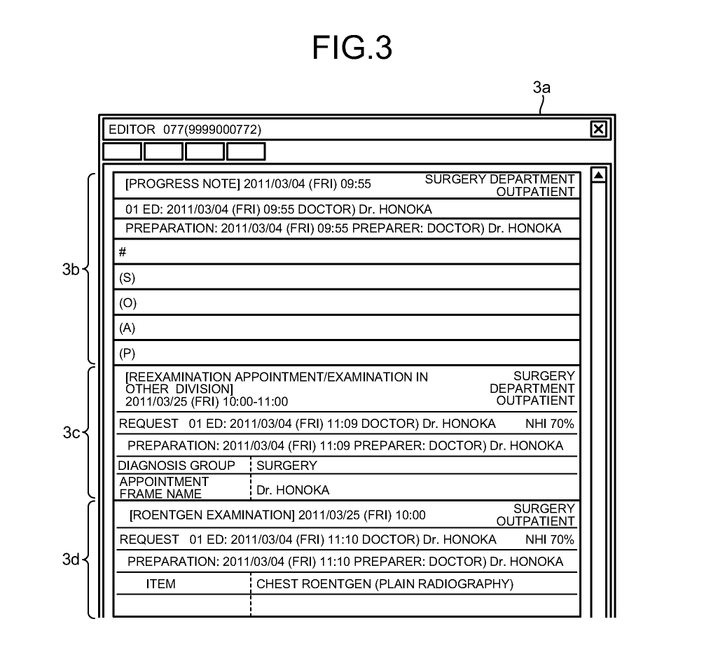

FIG. 3 is a diagram illustrating an example of the editor screen which is output by the execution unit. As illustrated in FIG. 3, an editor screen 3a, for example, is an editor screen regarding an examinee who is identified as identification information “077”. The editor screen 3a includes an area 3b in which the contents of a progress note are input, an area 3c in which the contents of the reexamination appointment/examination in other medical division are input, and an area 3d in which the contents of the examination appointment are input. Among these contents, the progress note, for example, represents the current diagnosis record. For example, the area 3b represents that the progress note was created about the progress in which the examinee visited the surgery department to be examined on the outpatient basis and was examined by the physician “Dr. Honoka” on Mar. 4, 2011. In addition, the area 3b is described with the case where the progress note is created in a “SOAP format”. In other words, the first letter “S” represents the subjective information; the second letter “O” represents the objective information; the third letter “A” represents the evaluation; and the last letter “P” represents the current plan. In addition, the reexamination appointment/examination in other medical division, for example, represents information on the appointment for the next diagnosis. For example, the area 3c represents that “Dr. Honoka” registered the appointment on Mar. 4, 2011 with the content indicating that the examinee was to visit the surgery department and to be examined on the outpatient basis on Mar. 25, 2011. In addition, the examination appointment, for example, represents information on the appointment for the examination. For example, the area 3d represents that “Dr. Honoka” registered the appointment on Mar. 4, 2011 with the content indicating that the examinee was to take the roentgen examination on Mar. 25, 2011. Further, information including the information in the areas 3b to 3d input in the editor screen is registered in the electronic medical chart as the medical treatment information on the current medical treatment.

For example, the execution unit 121 receives the medical treatment information on the progress note input to the editor screen from the input device 101. The execution unit 121 develops the medical treatment information on the received progress note in the area 3b of the editor screen. The execution unit 121 receives an instruction to register the medical treatment information displayed on the editor screen in the electronic medical chart from the input device 101, registers the medical treatment information in the electronic medical chart, and stores the electronic medical chart in the medical chart storage unit 111.

In addition, for example, the execution unit 121 receives an instruction to make an appointment for the reexamination from the input device 101, causes the output device 102 to display the appointment screen for the reexamination, and receives the medical treatment information on the reexamination appointment such as the contents of the reexamination and the reexamination appointment date through the appointment screen from the input device 101. In case of receiving the medical treatment information on the reexamination appointment, the execution unit 121 develops the area 3c in the editor screen. The execution unit 121 receives an instruction to register the medical treatment information on the reexamination appointment in the electronic medical chart from the input device 101, and registers the medical treatment information in the electronic medical chart or issues an order on the reexamination.

In addition, for example, the execution unit 121 receives an instruction to create the appointment for the examination, causes the output device 102 to display the appointment screen for the examination, and receives the medical treatment information on the examination appointment such as the contents of the examination and the examination appointment date through the appointment screen. In a case of receiving the medical treatment information on the examination appointment, the execution unit 121 develops the area 3d in the editor screen. When receiving an instruction to register the medical treatment information on the examination appointment in the electronic medical chart, the execution unit 121 registers the medical treatment information in the electronic medical chart or issues an order on the examination.

In a case of receiving a display request for the appointment screen for the examination which is granted to the patient, the determination unit 122 refers to the transfer storage unit 112, and determines an availability of the reexamination appointment date received by the execution unit as the examination appointment date. For example, in a case of receiving an instruction to display the appointment screen for the examination, the determination unit 122 refers to the transfer storage unit 112, and determines a transferability of the input reexamination appointment date of the examination related to the appointment to the examination appointment date. For example, in case where the examination related to the appointment is selected from an examination list, the determination unit 122 refers to the transfer storage unit 112 for the examination related to the appointment, and determines the transferability of the reexamination appointment date of the examination related to the appointment.

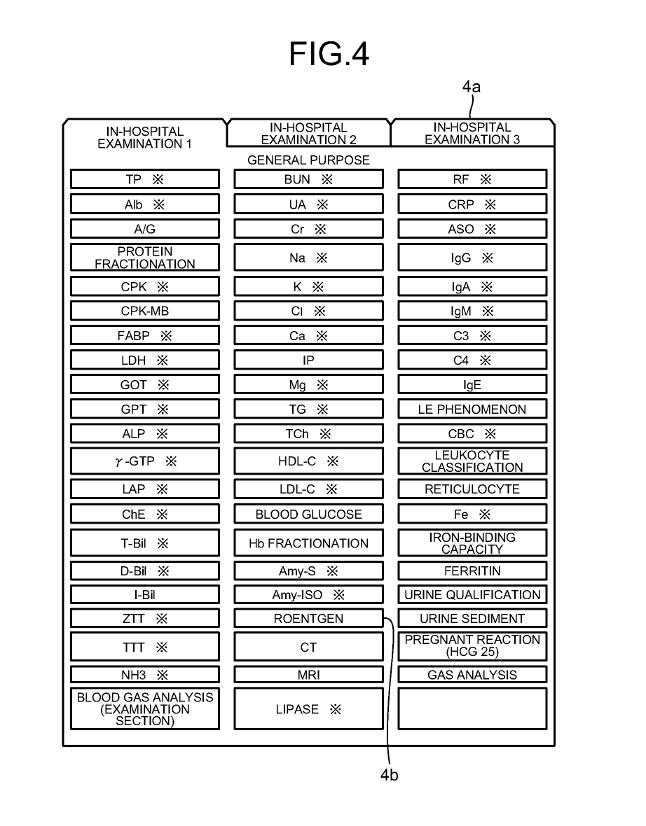

FIG. 4 is a diagram illustrating an example of the display screen of the examination list. As illustrated in FIG. 4, an examination list screen 4a includes buttons for designating various examinations performed in a medical institute. For example, when a button 4b for designating the roentgen is selected from the examination list screen 4a, the determination unit 122 refers to the transfer storage unit 112 illustrated in FIG. 2. In FIG. 2, since the examination category “roentgen” is associated with the transferability “◯”, the determination unit 122 determines that the roentgen is an examination of which the input reexamination appointment date is transferable to the examination appointment date. Then, the determination unit 122, for example, outputs the determination result to the output unit 123.

In a case where the determination unit 122 determines that the reexamination appointment date is available as the examination appointment date, the output unit 123 outputs the appointment screen in a format in which the reexamination appointment date is available as the examination appointment date. For example, in a case where the reexamination appointment date of the examination related to the appointment is transferable, the output unit 123 outputs the appointment screen including a next-diagnosis date button to the output device 102. The next-diagnosis date button is a button through which an instruction to transfer the input reexamination appointment date to the examination appointment date is received. In addition, for example, in a case where the determination unit 122 determines that the reexamination appointment date is available as the examination appointment date, the output unit 123 initializes an examination appointment date input field included in the appointment screen to display the current date, and outputs the appointment screen including a button through which an instruction to use the input reexamination appointment date as the examination appointment date is received.

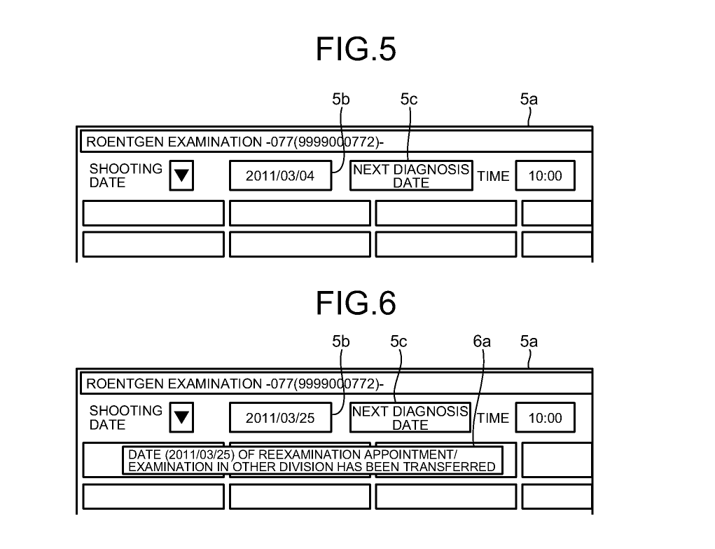

FIG. 5 is a diagram illustrating an example of the appointment screen which is output by the output unit. In the example illustrated in FIG. 5, the case where an appointment for the roentgen on Mar. 25, 2011 is registered on Mar. 4, 2011 will be described. As illustrated in FIG. 5, an appointment screen 5a includes a field 5b through which the examination appointment date is input, and a next-diagnosis date button 5c. In the field 5b, the current date, that is, “2011/03/04” is displayed as a default. For example, since the reexamination appointment date of the roentgen is transferable, the output unit 123 causes the output device 102 to display the appointment screen 5a including the next-diagnosis date button 5c. Further, for example, in a case where the appointment screen for the examination of which the reexamination appointment date is not transferable is output, the output unit 123 causes the output device 102 to display the appointment screen 5a including no next-diagnosis date button 5c.

In addition, for example, in a case where the next-diagnosis date button included in the output appointment screen is pressed, the output unit 123 determines whether or not there is the input reexamination appointment date in the editor screen. In a case where the reexamination appointment date is present, the output unit 123 causes the output device 102 to display the latest reexamination appointment date as the examination appointment date. On the other hand, in a case where there is no reexamination appointment date, the output unit 123 causes the output device 102 to display a message indicating “There is no reexamination appointment date in the editor screen”. Further, the current date is displayed in the field 5b of FIG. 5. In general, examinations having no limit on the examination frame practicable in the examination department may correspond to any one of a case where the examination is granted as well after the current medical treatment, and a case where the examination is granted in parallel with the next medical treatment. Accordingly, in the appointment screen, the field 5b is initialized to be set to the current date and the next-diagnosis date button 5c is disposed, so that the user can easily set any one of two dates having a high possibility to be set as the examination date.

FIG. 6 is a diagram illustrating an example of the appointment screen which is output by the output unit. In the example illustrated in FIG. 6, the case where the next-diagnosis date button 5c is pressed in the appointment screen 5a illustrated in FIG. 5 will be described. In addition, herein, the description will be made assuming that the input reexamination appointment date indicating “2011/03/25” is input in an editor screen 3a. When next-diagnosis date button 5c is pressed in the appointment screen 5a illustrated in FIG. 5, since the input reexamination appointment date is present in the editor screen 3a, the output unit 123 makes the field 5b display “2011/03/25” as illustrated in FIG. 6. In addition, for example, the output unit 123 changes a background color of the field 5b in which the input reexamination appointment date is displayed. In addition, for example, in a case where a mouse pointer overlaps the field 5b in which the input reexamination appointment date is displayed, the output unit 123 makes a tooltip 6a displayed, indicating “The date (2011/03/25) of the reexamination appointment/examination in other medical division has been transferred”. Further, for example, in a case where there is no reexamination appointment date input in the editor screen 3a, the output unit 123 causes the output device 102 to display a message indicating “There is no reexamination appointment date in the editor screen”. In addition, for example, in a case where there are the input reexamination appointment dates of “2011/03/25” and “2011/03/31” in the editor screen 3a, the output unit 123 makes the field 5b display “2011/03/25” as the reexamination appointment date closest to the current date.

Process

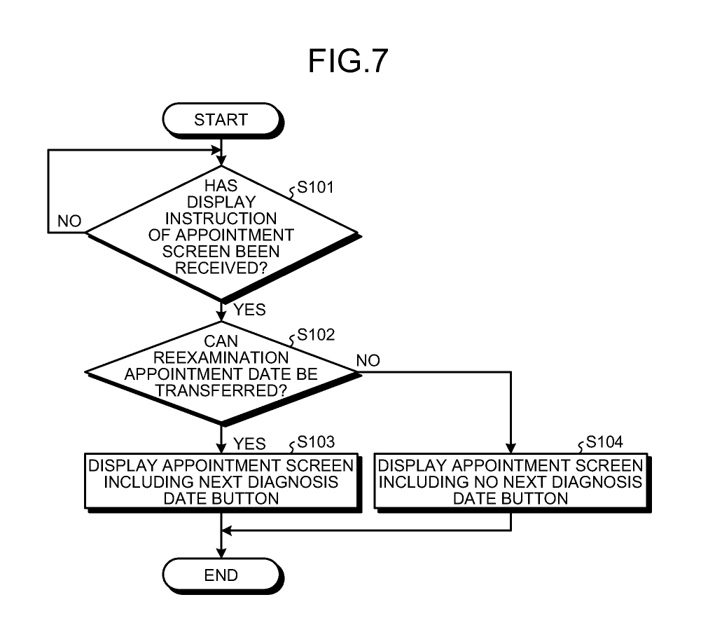

Next, a processing sequence of the medical treatment information input device 100 according to the first embodiment will be described. FIG. 7 is a flowchart illustrating the processing sequence of the medical treatment information input device according to the first embodiment. The process illustrated in FIG. 7, for example, is performed at a predetermined interval during power is being supplied from a power supply to the respective devices illustrated in the drawings.

As illustrated in FIG. 7, for example, when receiving the instruction to display the appointment screen for the examination (Yes in Step S101), the determination unit 122 refers to the transfer storage unit 112, and determines the transferability of the reexamination appointment date of the examination related to the appointment (Step S102).

In a case where the reexamination appointment date of the examination related to the appointment is transferable (Yes in Step S102), the output unit 123 causes the output device 102 to display the appointment screen including the next-diagnosis date button (Step S103) and ends the process.

On the other hand, in a case where the reexamination appointment date of the examination related to the appointment is not transferable (No in Step S102), the output unit 123 causes the output device 102 to display the appointment screen including no next-diagnosis date button (Step S104) and ends the process.

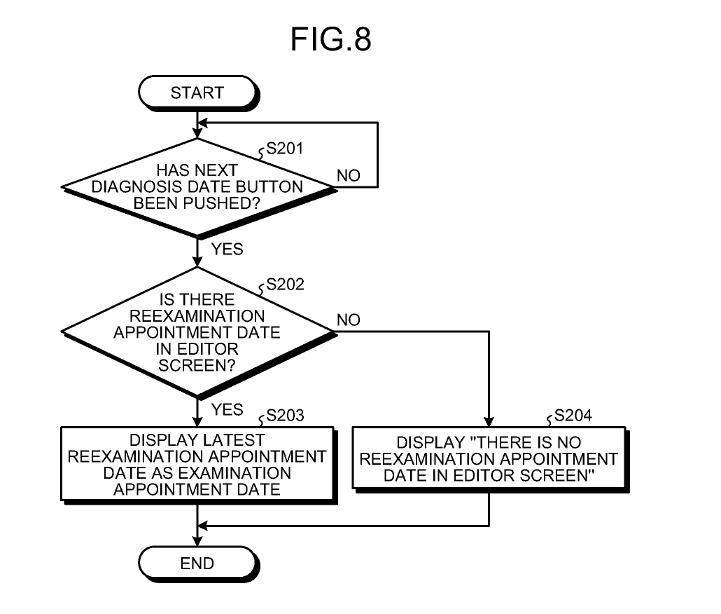

In addition, a processing sequence of the medical treatment information input device 100 in a case where the next-diagnosis date button is pressed will be described. FIG. 8 is a flowchart illustrating the processing sequence of the medical treatment information input device according to the first embodiment. As illustrated in FIG. 8, for example, when the next-diagnosis date button is pressed (Yes in Step S201), the determination unit 122 determines whether or not there is the reexamination appointment date in the editor screen (Step S202).

In a case where the reexamination appointment date is present in the editor screen (Yes in Step S202), the output unit 123 makes the latest reexamination appointment date displayed as the examination appointment date (Step S203) and ends the process. On the other hand, in a case where there is no reexamination appointment date in the editor screen (No in Step S202), the output unit 123 makes a message indicating “There is no reexamination appointment date in the editor screen” be displayed (Step S204) and ends the process.

Effects

Next, effects of the medical treatment information input device 100 according to the first embodiment will be described. The medical treatment information input device 100 receives the reexamination appointment date as an input through the display screen displaying the medical treatment information of a patient. In a case of receiving the display request for the appointment screen for the examination which is granted to the patient, the medical treatment information input device 100 refers to the storage unit which stores the respective categories of the plurality of examinations including the examination with being associated with information representing the availability of a reexamination appointment date as an examination appointment date. The medical treatment information input device 100 determines the availability of the received reexamination appointment date as an examination appointment date. In a case where it is determined that the received reexamination appointment date is available as the examination appointment date, the medical treatment information input device 100 outputs the appointment screen in a format in which the reexamination appointment date is available as the examination appointment date. For this reason, the medical treatment information input device 100 can make the input burden on the physician lightened. In addition, since it is determined whether or not the reexamination appointment date is on the editor screen, the medical treatment information input device 100 can efficiently transfer the reexamination appointment date related to the current medical division to the examination appointment date. In other words, even in a case where the reexamination appointments of other medical divisions are present, the reexamination date of the current division is transferable to the examination appointment.

For example, in a case where the reexamination and the examination are granted to an examinee on the outpatient basis, the reexamination appointment date and the examination appointment date may be arranged on the same date in consideration of the burden on the examinee. In this case, if the reexamination appointment date of the examination related to the appointment is transferable, the medical treatment information input device 100 transfers the input reexamination appointment date to the examination appointment date in response to the pressing of the next-diagnosis date button. Therefore, since there is no need to input the same date, the input burden on the physician can be lightened. In addition, in a case of the examination of which an examination result is expected on the very day of the examination, the examination is performed on the reexamination appointment date before the medical treatment. Therefore, the physician can perform the medical treatment on the basis of the examination result. Herein, it is preferable that the examination be performed on the reexamination appointment date for the examination category of which the examination result is expected on the very day. In other words, by setting the examination category of which the examination result is expected on the very day as the transferable examination category, it is possible for the patient to minimize the number of visiting hospital and the physician can effectively perform the medical treatment.

For example, regarding the examination related to the appointment, in a case where a number of days are taken to get the examination result and a case where the examination department is set in terms of an examination appointment frame, the medical treatment information input device 100 does not display the next-diagnosis date button on the appointment screen. For this reason, since the medical treatment information input device 100 prevents the input reexamination appointment date from being transferred to the examination appointment date by mistake, the necessity to input the examination appointment date once more is saved, so that the input burden on the physician can be lightened.

### [b] Second Embodiment

In the first embodiment, the description has been made in connection with the case where the current date is displayed as a default in the field in which the examination appointment date is input, and the input reexamination appointment date is displayed by the next-diagnosis date button. However, the invention may be configured such that the input reexamination appointment date is displayed in the field in which the examination appointment date is input. In a second embodiment, the description will be made in connection with the case where the input reexamination appointment date is developed in the field in which the examination appointment date is input.

Configuration

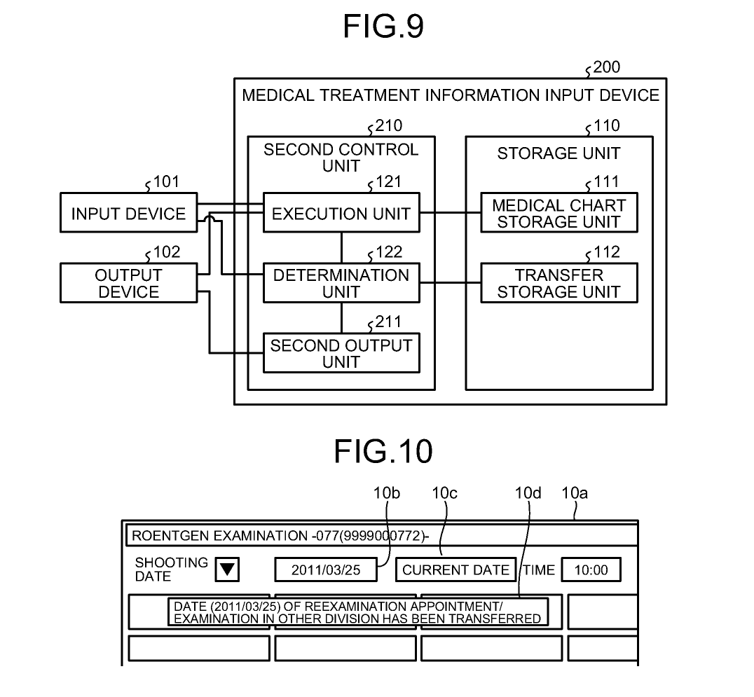

An example of a functional configuration of a medical treatment information input device according to the second embodiment will be described. FIG. 9 is a block diagram illustrating the functional configuration of the medical treatment information input device according to the second embodiment. As illustrated in FIG. 9, a medical treatment information input device 200 is provided with the storage unit 110 and a second control unit 210. In addition, the medical treatment information input device 200 is connected to the input device 101 and the output device 102. Herein, the descriptions of the input device 101, the output device 102, and the storage unit 110 illustrated in FIG. 9 are the same as those of the input device 101, the output device 102, and the storage unit 110 illustrated in FIG. 1, respectively.

The second control unit 210 is provided with the execution unit 121, the determination unit 122, and a second output unit 211. Among these units, the descriptions of the execution unit 121 and the determination unit 122 illustrated in FIG. 9 are the same as those of the execution unit 121 and the determination unit 122 illustrated in FIG. 1, respectively. The functions of the second control unit 210, for example, may be implemented by an integrated circuit such as an ASIC (Application Specific Integrated Circuit) or an FPGA (Field Programmable Gate Array). In addition, the functions of the second control unit 210, for example, may be implemented by causing a CPU (Central Processing Unit) to execute predetermined programs.

In a case where the determination unit 122 determines that the reexamination appointment date is transferable to the examination appointment date, the second output unit 211 causes the output device 102 to display the appointment screen in a format in which the input reexamination appointment date is transferred to the examination appointment date. For example, in a case where the reexamination appointment date of the examination related to the appointment is transferable, the second output unit 211 makes the latest reexamination appointment date among the input reexamination appointment dates displayed as the examination appointment date of the appointment screen. The second output unit 211 causes the output device 102 to display the appointment screen in which the reexamination appointment date is displayed.

FIG. 10 is a diagram illustrating an example of the appointment screen which is output by the output unit. In an example illustrated in FIG. 10, a case where an appointment for the roentgen to be performed on Mar. 25, 2011 is registered on Mar. 4, 2011 will be described. In addition, herein, the description will be made assuming that the input reexamination appointment date “2011/03/25” is present on the editor screen. As illustrated in FIG. 10, an appointment screen 10a includes a field 10b in which the examination appointment date is input, and a current date button 10c. For example, since the reexamination appointment date of the roentgen is transferable, the second output unit 211 makes the field 10b display “2011/03/25”. In addition, for example, in a case where the mouse pointer overlaps the field 10b in which the reexamination appointment date is developed, the second output unit 211 makes a tooltip 10d displayed, indicating “The date (2011/03/25) of the reexamination appointment/examination in other medical division has been transferred”. In addition, for example, when the current date button 10c is pressed, the second output unit 211 makes the field 10b display the current date, that is, “2011/03/04”. Then, the second output unit 211 outputs the appointment screen 10a to the output device 102. Further, for example, in a case where the input reexamination appointment dates “2011/03/25” and “2011/03/31” are present on the editor screen, the second output unit 211 makes the field 10b display “2011/03/25” as the reexamination appointment date closest to the current date. In addition, for example, in a case where the appointment screen for the examination of which the reexamination appointment date is not transferable is output, the second output unit 211 causes the output device 102 to display the appointment screen 10a in which the examination appointment date is left blank.

Process

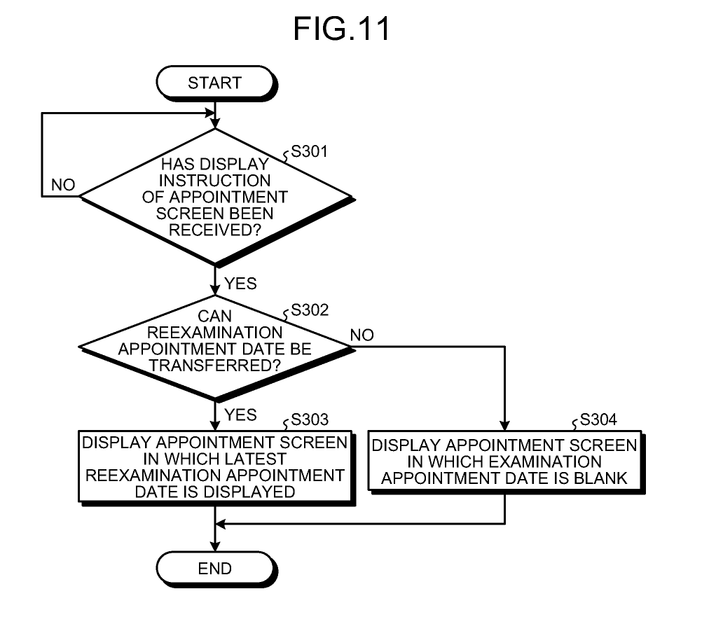

Next, a processing sequence of the medical treatment information input device 200 according to the second embodiment will be described. FIG. 11 is a flowchart illustrating the processing sequence of the medical treatment information input device according to the second embodiment. The process illustrated in FIG. 11, for example, is performed at a predetermined interval during power is being supplied from a power supply to the respective devices illustrated in the drawings.

As illustrated in FIG. 11, for example, when receiving the instruction to display the appointment screen of the examination (Yes in Step S301), the determination unit 122 refers to the transfer storage unit 112, and determines the transferability of the reexamination appointment date of the examination related to the appointment (Step S302).

In a case where the reexamination appointment date of the examination related to the appointment is transferable (Yes in Step S302), the second output unit 211 causes the output device 102 to display the appointment screen on which the latest reexamination appointment date is displayed (Step S303).

On the other hand, in a case where the reexamination appointment date of the examination related to the appointment is not transferable (No in Step S302), the second output unit 211 causes the output device 102 to display the appointment screen in which the examination appointment date is left blank (Step S304) and ends the process.

Effects

Next, effects of the medical treatment information input device 200 according to the second embodiment will be described. In a case of receiving a request for displaying the appointment screen for the examination, the medical treatment information input device 200 refers to the storage unit which stores the category of the examination with being associated with information representing the transferability of the input reexamination appointment date to the examination appointment date. The medical treatment information input device 200 determines the transferability of the input reexamination appointment date of the examination related to the appointment to the examination appointment date. In a case where it is determined that the examination related to the appointment is transferable, the medical treatment information input device 200 outputs the appointment screen in a format in which the input reexamination appointment date is transferred to the examination appointment date. For this reason, the medical treatment information input device 200 can lighten the input burden on the physician.

For example, in a case where the reexamination and the examination are granted to an examinee on the outpatient basis, the reexamination appointment date and the examination appointment date may be arranged on the same date in consideration of the burden on the examinee. In this case, if the reexamination appointment date of the examination related to the appointment is transferable, the medical treatment information input device 200 displays the appointment screen in which the input reexamination appointment date is transferred to the examination appointment date. Therefore, since there is no need to input the same date, the input burden on the physician can be lightened.

### Third Embodiment

Hitherto, embodiments of the invention have been described, but the invention may be implemented by other embodiments in addition to the above-described embodiments. Hereinafter, other embodiments will be described.

Data Center

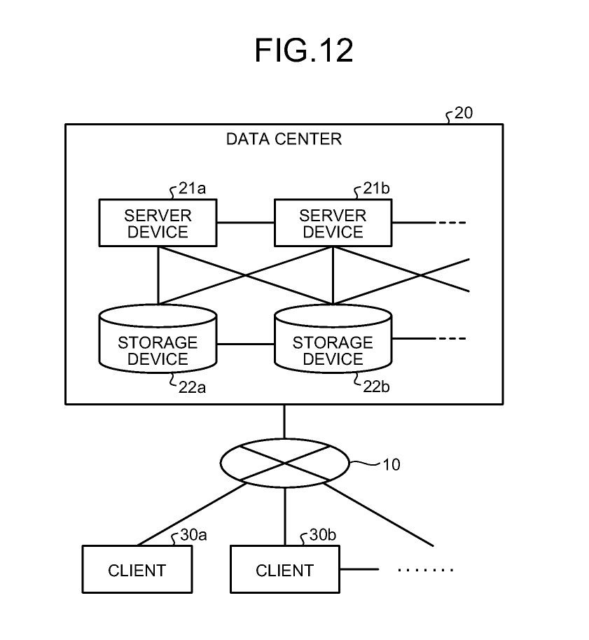

In the first and second embodiments, the description has been made in connection with the case where the medical treatment information input devices 100 and 200 are provided in a medical institute, but the invention is not limited thereto. For example, the medical treatment information input devices 100 and 200 may be applied to a data center which is connected to a plurality of medical institutes. FIG. 12 is a diagram illustrating an example of the application to the data center. As illustrated in FIG. 12, a data center 20, for example, is connected to clients 30a, 30b, and so on through a network 10. Examples of the network 10 may include any kind of communication network such as the Internet and a WAN (Wide Area Network) regardless of a wired or wireless system. In addition, the clients 30a, 30b, and so on are provided on the plurality of the medical institutes in a distributed manner. In addition, the data center 20 is provided with server devices 21a, 21b, and so on, and storage devices 22a, 22b, and so on. Further, herein below, the clients 30a, 30b, and so on will be collectively referred to as a client 30 when there is no need to distinguish therebetween. In addition, the server devices 21a, 21b, and so on will be collectively referred to as a server device 21 when there is no need to distinguish therebetween. In addition, the storage devices 22a, 22b, and so on will be collectively referred to as a storage device 22 when there is no need to distinguish therebetween.

For example, the data center 20 realizes the functions of the medical treatment information input devices 100 and 200 illustrated in FIGS. 1 and 9 as virtual machines using the server device 21. In addition, for example, the data center 20 stores the medical chart storage unit 111 and the transfer storage unit 112 illustrated in FIGS. 1 and 9 for every hospital in distinction from each other using the storage device 22.

For example, in the data center 20, a medical treatment information input VM (Virtual Machine) which is the virtual machine serving as the functions of the medical treatment information input devices 100 and 200 performs a process as follows. In other words, the medical treatment information input VM receives the reexamination appointment date as an input through the display screen displaying the medical treatment information of a patient. In a case of receiving the display request for the appointment screen for the examination which is granted to the patient, the medical treatment information input VM refers to the storage unit which stores the respective categories of the plurality of examinations including the examination with being associated with information representing the availability of a reexamination appointment date as an examination appointment date. The medical treatment information input VM determines the availability of the received reexamination appointment date as an examination appointment date. In a case where the determination unit determines that the received reexamination appointment date is available as the examination appointment date, the medical treatment information input VM outputs the appointment screen in a format in which the reexamination appointment date is available as the examination appointment date. For this reason, the medical treatment information input VM can make the input burden on the physician lightened.

Others

In addition, for example, some or all of the processes performed automatically as described above among the processes described in the first and second embodiments may be performed manually. Alternatively, some or all of the processes performed manually may be performed automatically using a known method. In addition, the processing sequence, a control sequence, specific names, and information including various kinds of data and parameters which are described and illustrated in the above-described specification and the drawings may be arbitrarily changed if not otherwise specified.

In addition, the respective constituent elements of the medical treatment information input devices 100 and 200 illustrated in FIGS. 1 and 9 have been described in a functional or conceptual sense, so that there is no need to be physically configured just as the drawings. In other words, the distributed/integrated specific forms of the medical treatment information input devices 100 and 200 are not limited to the drawings. However, some or all of the elements may be functionally or physically distributed/integrated in arbitrary units according to various kinds of loads, usage conditions, and the like. For example, an external storage device may be connected to the medical treatment information input devices 100 and 200 through the network, and information stored in the storage unit 110 may be stored in the external storage device.

In addition, the medical treatment information input devices 100 and 200 may be realized by mounting the respective functions of the medical treatment information input devices 100 and 200 on a given information processing device. The given information processing device, for example, corresponds to a device such as a personal computer, a workstation, a mobile phone, a PHS (Personal Handy-phone System) terminal, a mobile communication terminal, or a PDA (Personal Digital Assistant).

Program

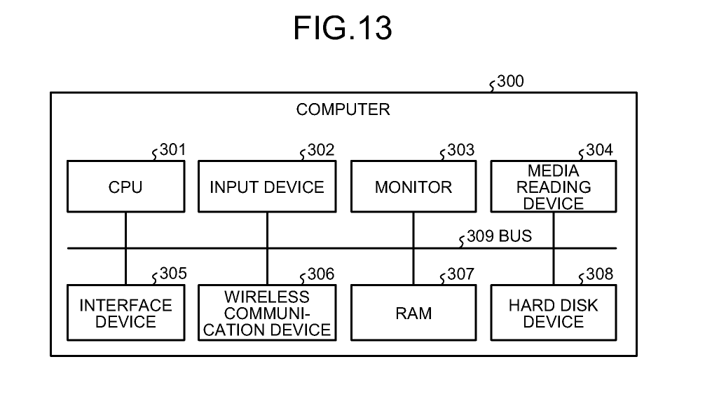

FIG. 13 is a diagram illustrating an example of a computer which executes a medical treatment information input program. As illustrated in FIG. 13, a computer 300 is provided with a CPU 301 which performs various kinds of arithmetic processing, an input device 302 which receives data as an input from a user, and a monitor 303. In addition, the computer 300 is provided with a media reading device 304 which reads programs or the like from a storage media, an interface device 305 which serves to make a connection with other devices, and a wireless communication device 306 which serves to make a wired or wireless connection with other devices. In addition, the computer 300 is provided with a RAM (Random Access Memory) 307 which temporarily stores various kinds of information and a hard disk device 308. In addition, the devices 301 to 308 each are connected to a bus 309.

In the hard disk device 308, the medical treatment information input programs which contain the functions similar to those of the respective process units of the determination unit 122 and the output units 123 and 211 illustrated in FIGS. 1 and 9 are stored. In addition, the hard disk device 308 stores various kinds of data for realizing the medical treatment information input programs.

The CPU 301 reads the respective programs stored in the hard disk device 308, develops the programs in the RAM 307, and performs various kinds of processes. In addition, these programs can cause the computer to serve as the determination unit 122 and the output units 123 and 211 illustrated in FIGS. 1 and 9.

Further, the above-described medical treatment information input programs are not necessarily stored in the hard disk device 308. For example, programs stored in a computer-readable recording medium may be read and executed by the computer 300. The computer-readable recoding medium, for example, corresponds to a portable recording medium such as a CD-ROM, a DVD disk, and USB memory, semiconductor memory such as flash memory, and a hard disk drive. In addition, the programs may be stored in a device which is connected to a public line, the Internet, a LAN (Local Area Network), a WAN (Wide Area Network) or the like, and the computer 300 may read and execute these programs.

According to an aspect of technologies disclosed in the application, a burden on a physician of inputting data can be lightened.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A medical treatment information input device comprising:
a processor; and
a memory that stores information representing an availability of a reexamination appointment date as an examination appointment date for respective categories of a plurality of examinations, wherein the processor executes:
determining including referring to the memory, and determining availability of the reexamination appointment date input through a display screen displaying medical treatment information of a patient as an examination appointment date; and
outputting the appointment screen in a format in which the reexamination appointment date is available as the examination appointment date in a case where it is determined that the reexamination appointment date is available as the examination appointment date through the determining of the availability.

2. The medical treatment information input device according to claim 1, wherein
the outputting includes initializing an examination appointment date input field included in the appointment screen to be set the current date in a case where it is determined that the reexamination appointment date is available as the examination appointment date through the determining of the availability, and outputting the appointment screen including a button through which an instruction to use the input reexamination appointment date as the examination appointment date is received.

3. The medical treatment information input device according to claim 1, wherein
the determining availability of the reexamination appointment date includes determining that the reexamination appointment date is available as the examination appointment date in a case where the examination is an examination of a category of which an examination result is expected on the day of the examination.

4. The medical treatment information input device according to claim 1, wherein
the determining availability of the reexamination appointment date includes determining the reexamination appointment date is available as the examination appointment date in a case where the examination is an examination of a category in which there is no need to designate an appointment frame.

5. A computer readable storage medium storing therein a medical treatment information input program causing a computer to execute:
determining including referring to a storage unit which stores information representing an availability of a reexamination appointment date as an examination appointment date for respective categories of a plurality of examinations, and determining availability of the reexamination appointment date input through a display screen displaying medical treatment information of the patient as an examination appointment date; and
outputting the appointment screen in a format in which the reexamination appointment date is available as the examination appointment date in a case where it is determined that the reexamination appointment date is available as the examination appointment date through the determining of the availability.

6. The computer readable storage medium according to claim 5, wherein
the outputting includes initializing an examination appointment date input field included in the appointment screen to be set the current date in a case where it is determined that the reexamination appointment date is available as the examination appointment date through the determining of the availability, and outputting the appointment screen including a button through which an instruction to use the input reexamination appointment date as the examination appointment date is received.

7. The computer readable storage medium according to claim 5, wherein
the determining availability of the reexamination appointment date includes determining that the reexamination appointment date is available as the examination appointment date in a case where the examination is an examination of a category of which an examination result is expected on the day of the examination.

8. The computer readable storage medium according to claim 5, wherein
the determining availability of the reexamination appointment date includes determining the reexamination appointment date is available as the examination appointment date in a case where the examination is an examination of a category in which there is no need to designate an appointment frame.

9. A medical treatment information input method which is performed by a server device connected to a terminal through a network, the medical treatment information input method comprising:
determining including referring to a storage unit which stores the respective categories of a plurality of examinations including the examination with being associated with information representing an availability of the reexamination appointment date as the examination appointment date in a case of receiving a display request for an appointment screen for an examination which is granted to a patient, and determining availability of the reexamination appointment date input through a display screen displaying medical treatment information of the patient as the examination appointment date, using a processor; and
outputting, using the processor, the appointment screen in a format in which the reexamination appointment date is available as the examination appointment date in a case where it is determined that the reexamination appointment date is available as the examination appointment date through the determining of the availability.

10. The medical treatment information input method according to claim 9, wherein
the outputting includes initializing an examination appointment date input field included in the appointment screen to be set the current date in a case where it is determined that the reexamination appointment date is available as the examination appointment date through the determining of the availability, and outputting the appointment screen including a button through which an instruction to use the input reexamination appointment date as the examination appointment date is received.

11. The medical treatment information input method according to claim 9, wherein
the determining availability of the reexamination appointment date includes determining that the reexamination appointment date is available as the examination appointment date in a case where the examination is an examination of a category of which an examination result is expected on the very day of the examination.

12. The medical treatment information input method according to claims 9, wherein
the determining availability of the reexamination appointment date includes determining the reexamination appointment date is available as the examination appointment date in a case where the examination is an examination of a category in which there is no need to designate an appointment frame.
